(19) United States
(12) Patent Application Publication
(10) Pub. No.: US 2007/0032888 A1
(43) Pub. Date: Feb. 8, 2007

(54) Control apparatus, communication device, and communication method

(75) Inventors: Takashi Hirata, Yokohama-shi (JP); Kenichi Fujii, Yokohama-shi (JP); Masaki Shitano, Yokohama-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/492,811

(22) Filed: Jul. 26, 2006

(30) Foreign Application Priority Data
Aug. 3, 2005 (JP) 2005-225550

(51) Int. Cl. G05B 15/00; G05B 11/01

(52) U.S. Cl. 700/19; 700/1; 700/20

(57) ABSTRACT

A control apparatus receives, from a device to be controlled, information concerning the device and related to time, obtains specific-time information concerning the device to be controlled, on the basis of the received information concerning the device to be controlled and related to time, and controls the device to be controlled, on the basis of the specific-time information.

### BACKGROUND OF THE INVENTION

1. Field of the Invention

The present invention relates to a control apparatus, control method, communication device, and communication method.

2. Description of the Related Art

With the progress of computer technologies, office machines and general household appliances which conventionally have only a single function and cannot be organically interconnected are connected across a network and execute processing in association with each other. As network techniques which realize this fusion of device controllers across networks, device control protocols such as UPnP (Universal Plug and Play), Jini, and Jxta are known.

UPnP will be explained below as a representative example of these device control protocols. UPnP is a device control protocol which is practically a de facto standard in the Internet world, and used on a network which supports protocols such as IP (Internet Protocol), TCP (Transfer Control Protocol), UDP (User Datagram Protocol), HTTP (Hyper Text Transfer Protocol), and XML (extensible Markup Language).

UPnP uses SSDP (Simple Service Discover Protocol) to find a device controller connected to a network. UPnP also uses the SSDP to detect profile information which expresses the predefined specifications and setting of a device controller to be controlled. The SSDP is the basic portion of UPnP, and the standard specifications of the SSDP are issued from IETF. IP broadcasting is used to find a device.

Also, the profile information indicating the predefined specifications and setting and practical functions of a device controller to be controlled is exchanged simultaneously. Note that the data format used in the information exchange is XML, and the data is communicated by HTTP.

SOAP is used to control a device. A UPnP control request is a SOAP message containing an action which calls a parameter by designating it. The response is also a SOAP message and contains a status, and the value and parameter are returned.

Device control protocols represented by UPnP and used to interconnect devices across a network often use the structure of profile information capable of expressing the latest snap shot. However, detailed profile information cannot be obtained by the latest snap shot alone. Therefore, an operation log collecting system capable of collecting, as profile information, not only the snap shot but also data such as user's content browsing log and operation log which can be managed in the form of a list is proposed (e.g., Japanese Patent Laid-Open No. 2001-209603).

As described above, device control protocols represented by UPnP often use the structure of profile information capable of expressing the present snap shot. In practice, however, profile information, particularly, status information has many items which change in accordance with a time series. Examples are software version information and a power status. Unfortunately, the structure of profile information used by device control protocols represented by UPnP cannot express, in accordance with a time series, these pieces of information which change in accordance with a time series. To perform log collection, change prediction, or the like for these items, therefore, a unique method must be used not in middleware which handles a device control protocol but in an application.

In addition, although the system which collects an operation log and browsing log exists as disclosed in Japanese Patent Laid-Open No. 2001-209603, the operation log and browsing log are lists which were operated and browsed in the past when profile information was obtained. That is, this snap shot was obtained when the profile information was obtained. Accordingly, it is impossible to express how the operation log and browsing log have changed in accordance with a time series.

Also, EP511143 describes a technique by which an interface object for expressing the ability of a software module is transmitted to a server, and the server updates and returns the object. More specifically, a function wanted by module A is registered on a server, and whether the interface object of module B matches the function is investigated via the server, thereby determining whether module B is necessary for module A. This technique is premised on the existence of an always usable server, in order to register functions of individual software modules. Therefore, the technique is inapplicable to a device to be used in a network which is temporarily constructed in a house or outdoors.

### SUMMARY OF THE INVENTION

It is an object of the present invention to provide a control apparatus, method, and program which control a device to be controlled, on the basis of specific-time information concerning the device to be controlled.

It is also an object of the present invention to provide a control apparatus comprising a receiving unit adapted to receive, from a device to be controlled, information concerning the device and related to time, an obtaining unit adapted to obtain specific-time information concerning the device to be controlled, on the basis of the information concerning the device to be controlled, related to time, and received by the receiving unit, and a control unit adapted to control the device to be controlled, on the basis of the specific-time information.

It is another object of the present invention to adapt middleware installed in a device connected to a network.

It is also an object of the present invention to provide a communication device which communicates with another device across a network, comprising a receiving unit adapted to receive, from the other device, information concerning the other device and related to time, and a configuration unit adapted to configure middleware on the basis of the information concerning the other device, related to time, and received by the receiving unit.

Further features of the present invention will become apparent from the following description of exemplary embodiments (with reference to the attached drawings).

### BRIEF DESCRIPTION OF THE DRAWINGS

FIG. 1 is a view showing the arrangement of an overall profile management system according to an embodiment of the present invention;

FIG. 2 is a view for explaining an outline of the configuration of the profile management system according to the embodiment of the present invention;

FIG. 3A is a view showing the structure of a profile used in the profile management system according to the embodiment of the present invention;

FIG. 3B is a view showing an example in which the profile structure shown in FIG. 3A is described in XML;

FIG. 4A is a view showing an example in which a snap shot of the latest profile information is formed from the profile structure shown in FIGS. 3A and 3B;

FIG. 4B is a view showing an example in which a snap shot of profile information at 13:00, Feb. 1, 2004 is formed from the profile structure shown in FIGS. 3A and 3B;

FIG. 5 is a system block diagram when the profile management system according to the embodiment of the present invention is realized by using a PC (Personal Computer);

FIG. 6 is a view for explaining an application module configuration executed by a device controller connected to the profile management system according to the embodiment of the present invention;

FIG. 7 is a flowchart for explaining processing by which a device control application 600 obtains profile information in the profile management system according to the embodiment of the present invention;

FIG. 8 is a flowchart for explaining processing by which the device control application 600 obtains the effective range of the value of the profile information in the profile management system according to the embodiment of the present invention;

FIG. 9 is a flowchart for explaining a profile exchange procedure performed between two device controllers different in profile information in the profile management system according to the embodiment of the present invention;

FIG. 10 is a block diagram showing the arrangement of a color printer as an example of a device which executes processing according to the embodiment;

FIG. 11 is a view showing the configuration of software installed in the color printer according to the embodiment of the present invention;

FIG. 12 is a view conceptually showing processing which occurs when the color printer according to the embodiment is powered on to start operating;

FIG. 13 is a view showing the state in which several built-in middleware programs of the color printer according to the embodiment stop operating due to an adaptation process using group capability and device capability in the color printer;

FIG. 14 is a view showing a case in which recursive adaptation is performed by generating group capability information again from changed device capability information in the color printer according to the embodiment;

FIG. 15 is a view for explaining the functional blocks of the software structure of the color printer according to the embodiment of the present invention; and

FIG. 16 is a flowchart for explaining an outline of a middleware control configuration process according to the embodiment of the present invention.

### DESCRIPTION OF THE EMBODIMENTS

The first embodiment of the present invention will be explained below with reference to the accompanying drawings. Although one practical embodiment will be described below, the present invention is not limited to this practical embodiment.

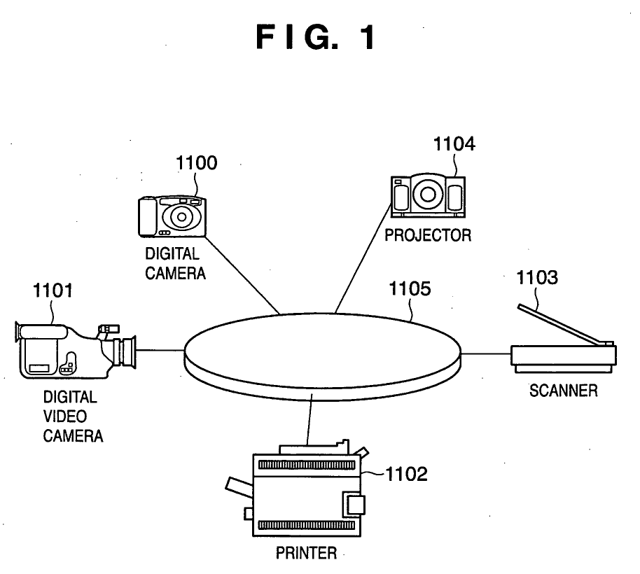

FIG. 1 is a view showing the overall profile management system according to the embodiment of the present invention. As shown in FIG. 1, in this profile management system, a digital camera 1100, digital video camera 1101, printer 1102, scanner 1103, and projector 1104 are connected to each other across a network 1105. Note that the five types of devices are connected to the network 1105 in this embodiment, but the present invention is not limited to these types of devices.

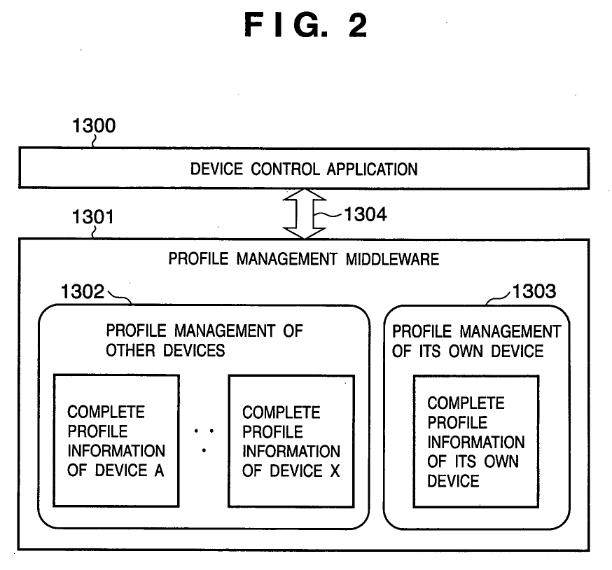

FIG. 2 is a view for explaining an outline of the arrangement of the profile management system according to the embodiment of the present invention. The structure of a profile according to the present invention shown in FIG. 2 can process information which changes in accordance with a time series. Accordingly, profile management middleware 1301 need only have one profile information for each device, regardless of whether the device is its own device 1303 or another device 1302. Also, an API 1304 which is disclosed to a device control application 1300 by the profile management middleware 1301 can provide processes of, e.g., referring to and manipulating log information, these processes can be abstracted and shared. In addition, since the API 1304 can refer to and manipulate the log information, the device control application 1300 need not perform any unique processing concerning the log information.

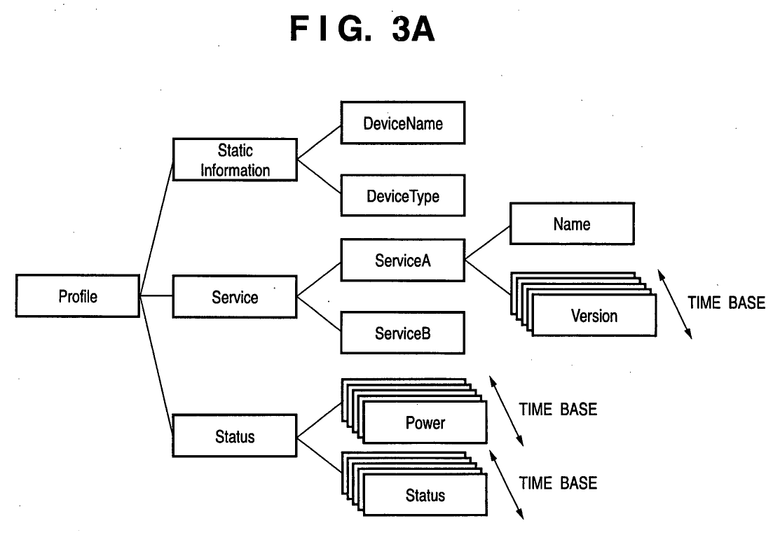

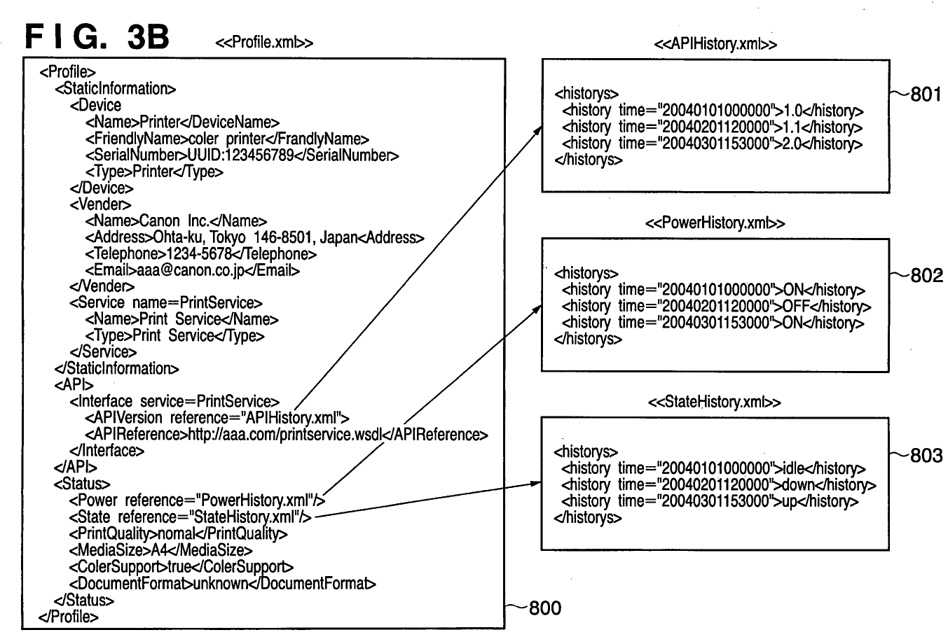

FIG. 3A is a view showing the structure of a profile used in the profile management system according to the embodiment of the present invention. FIG. 3B is a view showing an example in which the profile structure shown in FIG. 3A is described in XML. As shown in FIGS. 3A and 3B, status information such as API version, Power, and Status change in accordance with a time series. Therefore, the time base is introduced to make it possible to cope with the time-series changes.

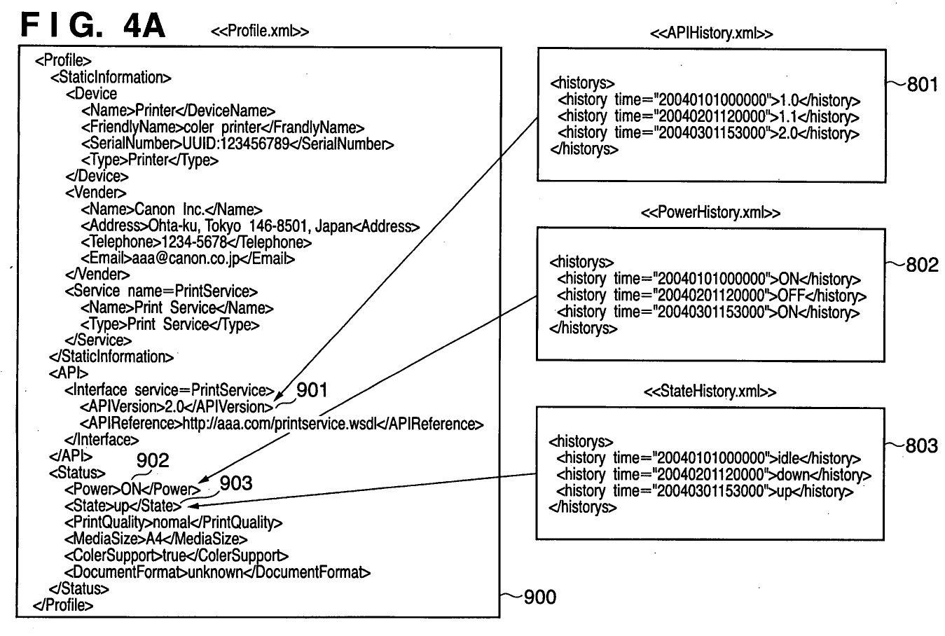

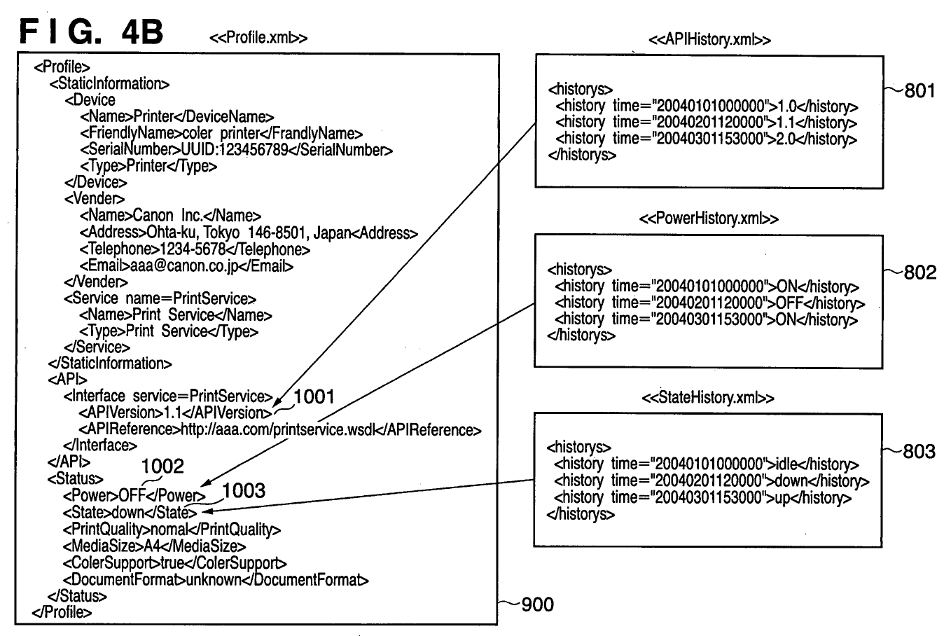

FIG. 4A is a view showing an example in which a snap shot of the latest profile information is formed from the profile structure shown in FIGS. 3A and 3B.

FIG. 4B is a view showing an example in which a snap shot of profile information at 13:00, Feb. 1, 2004 is formed from the profile structure shown in FIGS. 3A and 3B. As shown in FIG. 4B, it is also possible to form a snap shot of the past profile information by retracing the time base. Note that individual items in the profile structures shown in FIGS. 3A to 4B are examples, and the present invention is not limited to these items.

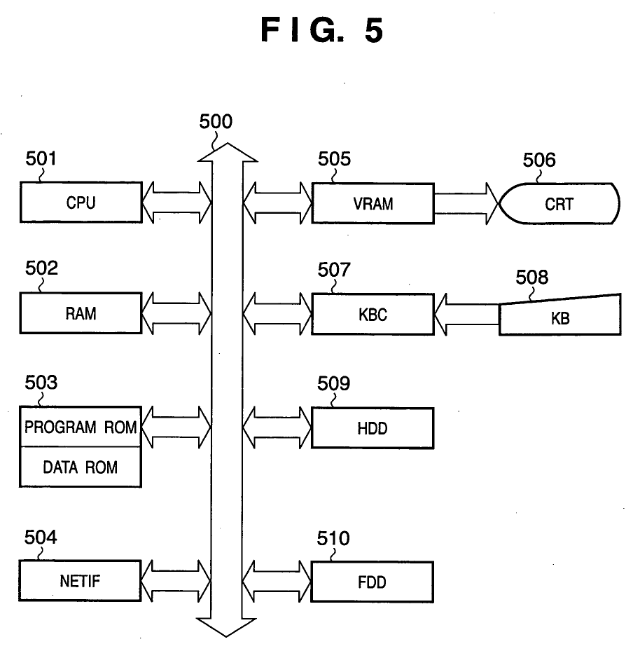

A device controller connected to the file management system according to the embodiment of the present invention will be explained below. FIG. 5 is a system block diagram when the profile management system according to the embodiment of the present invention is realized by using a PC (Personal Computer). Note that the device controller may also be achieved by a workstation, notebook PC, or palmtop PC, instead of a PC. It is also possible to use any of various household electric appliances such as a television set incorporating a computer, a game machine having a communication function, a telephone, a facsimile apparatus, a cell phone, a terminal having a communication function of communicating with another device such as a digital pocketbook, or a combination of these devices.

In FIG. 5, reference numeral 501 denotes a central processing unit (CPU) which controls the computer system; and 502, a random access memory (RAM) which functions as a main memory of the CPU 501, an area for an execution program, and an execution area and data area of the program.

Reference numeral 503 denotes a read only memory (ROM) recording operation procedures of the CPU 501. The ROM 503 includes a program ROM recording basic software (OS) as a system program for controlling the PC, and a data ROM recording information and the like necessary to operate the system. Note that an HDD 509 (to be described later) may also be used instead of the ROM 503 in some cases.

Reference numeral 504 denotes a network interface (NETIF) which controls data transfer between computer systems across the network, and also diagnoses the connection states; 505, a video RAM (VRAM) which rasterizes image data to be displayed on the screen of a CRT 506 (to be described later) for displaying the operating state of the computer system, and controls the display. Reference numeral 506 denotes a display device, e.g., a display. The display device 506 will be referred to as a CRT hereinafter.

Reference numeral 507 denotes a controller which controls input signals from an external input device 508 which accepts operations performed on the computer system by the user of the computer system. The external input device 508 is, e.g., a keyboard. Reference numeral 509 denotes a storage device, e.g., a hard disk drive. The storage device 509 will be referred to as an HDD hereinafter. The HDD 509 is used to store application programs and data such as image information. Note that application programs in this embodiment are, e.g., software programs for executing various device control means constituting this embodiment.

Reference numeral 510 denotes an external I/O device, e.g., a removable storage device, and is used to read out the above-mentioned application programs and the like from the medium. The external I/O device 510 will be referred to as an FDD hereinafter. Note that the application programs and data stored in the HDD 509 may also be stored in the FDD 510.

In FIG. 5, reference numeral 500 denotes an I/O bus (including an address bus, data bus, and control bus) which connects the individual units described above.

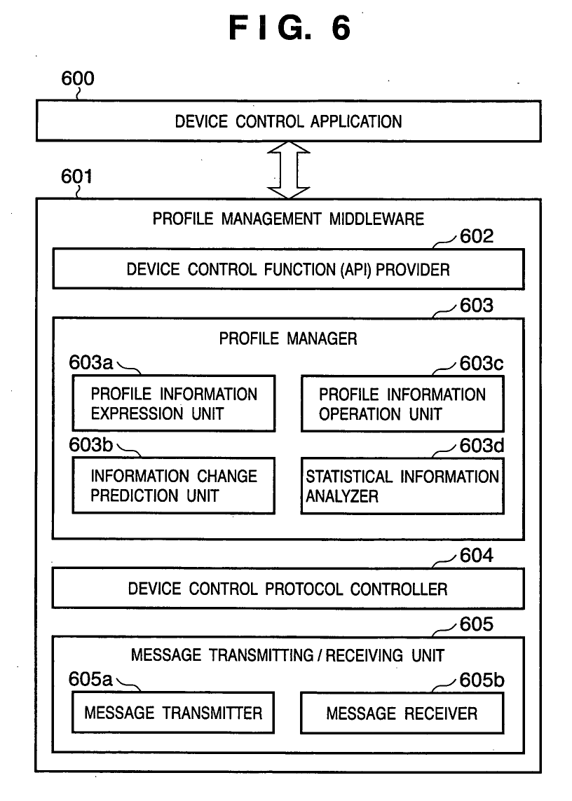

FIG. 6 is a view for explaining an application module configuration executed by the device controller connected to the profile management system according to the embodiment of the present invention.

As shown in FIG. 6, the device controller connected to the profile management system has a device control application 600 and profile management middleware 601. The profile management middleware 601 includes a profile control function (API) provider 602, profile manager 603, device control protocol controller 604, and message transmitting/receiving unit 605. The profile manager 603 includes a profile information expression unit 603a, information conversion prediction unit 603b, profile operation unit 603c, and statistical information analyzer 603d. The message transmitting/receiving unit 605 includes a message transmitter 605a and message receiver 605b.

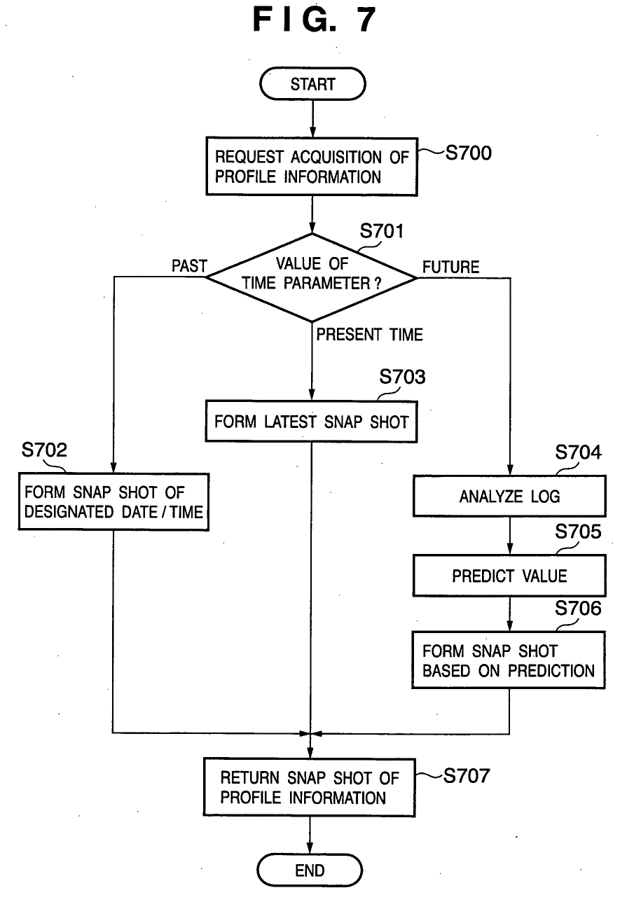

FIG. 7 is a flowchart for explaining processing by which the device control application 600 acquires profile information in the profile management system according to the embodiment of the present invention.

First, the device control application 600 transmits a profile information acquisition request to the profile management middleware 601 by using the API provided by the device control function (API) provider 602 (step S700). This profile information acquisition request contains a time parameter.

Then, the profile management middleware 601 having received the profile information acquisition request by the API performs the following determination (step S701). That is, the profile management middleware 601 determines whether the value of the time parameter obtained by the API indicates the present time, past, or future, in order to form the requested profile information by the profile information expression unit 603a.

If it is determined in step S701 that the value indicates the past, the profile information expression unit 603a forms a snap shot of the designated date/time from the stored profile information (step S702). If it is determined in step S701 that the value indicates the present time, the profile information expression unit 603a forms the latest snap shot from the stored profile information (step S703).

If it is determined in step S701 that the value indicates the future, the information change prediction unit 603b analyzes the log information (step S704), and predicts a future value from the result of the analysis (step S705). For example, for status information such as the power status which repeats ON and OFF, the information change prediction unit 603b predicts how the status changes in the future, on the basis of the log information. Subsequently, the profile information expression unit 603a forms a profile information snap shot to be returned, by using the value predicted in step S705 (step S706).

Then, the profile information snap shot formed in step S702, S703, or S706 is returned to the device control application 600 (step S707). Note that the log of profile information is returned if a profile information acquisition request containing a parameter for obtaining the log of profile information is received.

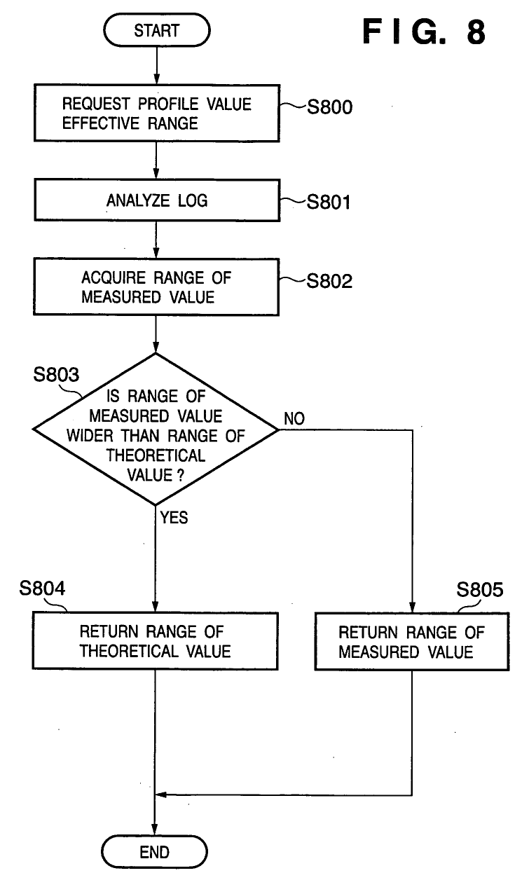

FIG. 8 is a flowchart for explaining processing by which the device control application 600 acquires the effective range of the value of profile information in the profile management system according to the embodiment of the present invention.

First, the device control application 600 transmits a profile value effective range request to the profile management middleware 601 by using the API provided by the device control function (API) provider 602 (step S800). Then, the profile management middleware 601 having received the profile value effective range acquisition request analyzes the profile value of the requested item by the statistical information analyzer 603d (step S801).

On the basis of the result of the analysis in step S801, the statistical information analyzer 603d acquires a measured value range (step S802). Then, whether the measured value range is wider than theoretical ranges (e.g., four ranges Ready, Transiting, Sleep, and Down for the system status) is determined (step S803).

If it is determined in step S803 that the measured value range is wider than the theoretical value ranges (Yes), the theoretical value ranges are returned (step S804). If it is determined that the measured value range is equal to or narrower than the theoretical value ranges (No), the measured value range is returned (step S805). Note that if the measured value range and theoretical value ranges are equal, either the measured value range or theoretical value ranges can be returned. That is, the same result is returned regardless of whether the measured value range or theoretical value ranges are returned.

FIGS. 7 and 8 are explained by taking the device control application 600 and profile management middleware 601 of the same device controller as examples. If these application and middleware are connected across a network, various requests are received by the message receiver 605b, and various responses are transmitted from the message transmitter 605a.

Note that the Internet Protocol (IP) is used in the transmission from the message transmitter 605a and the reception by the message receiver 605b. In this case, both versions IPv4 and IPv6 of the IP can be used. A medium actually used as a communication path can be either a wired or wireless medium. Depending on the device control protocol, it is also possible to use a communication protocol such as TCP, UDP, HTTP, SMTP, SNMP, or FTP.

Assume, for example, that device A cannot control device B because the software version of device A is 1.0 and that of device B is 2.0. In this case, device A can control device B by rolling back the profile of device B to the state in which the software version is 1.0.

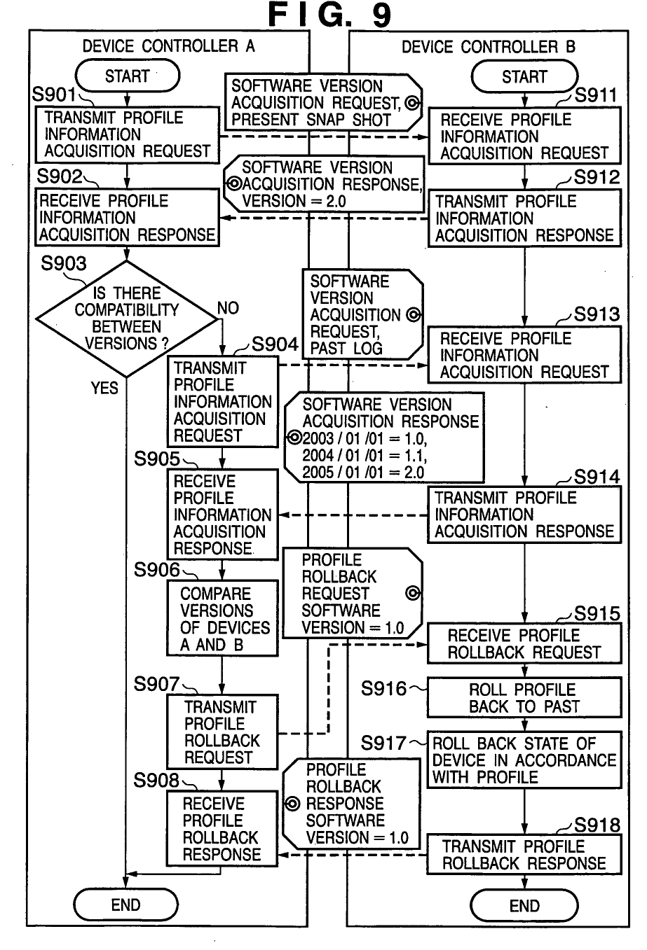

FIG. 9 is a flowchart for explaining a profile exchange procedure performed between two device controllers different in profile information in the profile management system according to the embodiment of the present invention. Note that in FIG. 9, the software version of device A is 1.0 and that of device B is 2.0, i.e., devices A and B are different in profile information.

First, device controller A causes the message transmitter 605a to transmit a profile information acquisition request to device controller B, in order to acquire the present software version (step S901).

Then, device controller B causes the message receiver 605b to receive the profile information acquisition request transmitted from device controller A (step S911).

The message transmitter 605a of device controller B transmits 2.0 as the present software version to device controller A (step S912). Note that this process corresponds to steps S703 and S707.

The message receiver 605b of device controller A receives the present software version transmitted from device controller B (step S902). Device controller A then determines whether its own software version and the software version of device controller B have compatibility (i.e., whether these software versions are compatible) (step S903). If it is determined in step S903 that there is compatibility (Yes), the processing is terminated. If it is determined in step S903 that there is no compatibility (No), the following operation is performed. That is, device controller A causes the message transmitter 605a to transmit a profile information acquisition request to device controller B, in order to acquire the log of the software version of device controller B (step S904).

The message receiver 605b of device controller B receives the profile information acquisition request for acquiring the software version log from device controller A (step S913). Then, the message transmitter 605a of device controller B transmits the software version log to device controller A (step S914).

The message receiver 605b of device controller A receives the software version log transmitted from device controller B (step S905). Device controller A compares its own software version with the software version log of device controller B, and determines whether there is a version having compatibility (step S906). That is, device controller A determines whether the same software version as its own software version exists.

The message transmitter 605a of device controller A transmits a profile rollback request to device controller B (step S907). This process is performed to roll back the software version of device controller B to 1.0 which is a software version having compatibility with the software version of device controller A (i.e., the same software version as its own software version).

The message receiver 605b of device controller B receives the profile rollback request transmitted from device controller A (step S915). Device controller B then rolls back its profile information to the past state in which the software version is 1.0 (step S916). In addition, device controller B rolls back its own state in accordance with the rolled back profile information (step S917). That is, device controller B uninstalls the software whose software version is 2.0, and reloads and installs the software whose software version is 1.0 from its own software log.

Note that the device controller reloads the software from its own log in the example shown in FIG. 9, but the present invention is not limited to this example. For instance, it is also possible to use a method by which the past version is downloaded from a server apparatus or the like and installed.

Device controller B causes the message transmitter 605a to transmit, to device controller A, a message indicating that the profile and state of device controller B are successfully rolled back in accordance with the request (step S918), and terminates the profile exchanging process.

Device controller A causes the message receiver 605b to receive the message indicating the success of the roll back from device controller B (step S908), and terminates the profile exchanging process.

In this embodiment as explained above, the profile information such as the predefined specifications, setting, and log of a device controller is expressed by a three-dimensional structure into which the time base of information is introduced in addition to the parent-child relationship and brotherly relationship of the information. Accordingly, not only a snap shot of the present profile information but also the past profile information can be reproduced by retracing the time base. It is also possible to abstract and share processes of, e.g., referring to and acquiring the log information, which are performed by applications independently of each other.

In addition, the change in profile information of a device controller with time is analyzed. This makes it possible to predict how the status of status information such as the power status which repeats ON and OFF changes in the future.

Also, when the CPU activity ratio of the PC theoretically takes a value of 0 to 100, a value of 80 to 100 can be returned as a measured value of the CPU activity ratio. That is, it is possible by acquiring a profile to detect that the PC is always operating in a high-load state in which the CPU activity ratio is 80 to 100.

Furthermore, when the profile information of a device controller has theoretical ranges, statistical information indicating the change in information with time is analyzed. If an actually used value differs from the theoretical value ranges of a status, more accurate actual theoretical value ranges can be presented. For example, as the theoretical value ranges of a status, the system status has four ranges Ready, Transiting, Sleep, and Down.

The second embodiment will be described in detail below with reference to the accompanying drawings. Note that the following embodiment does not limit inventions according to the scope of claims, and not all combinations of characteristic features explained in this embodiment are essential to the solving means of the inventions.

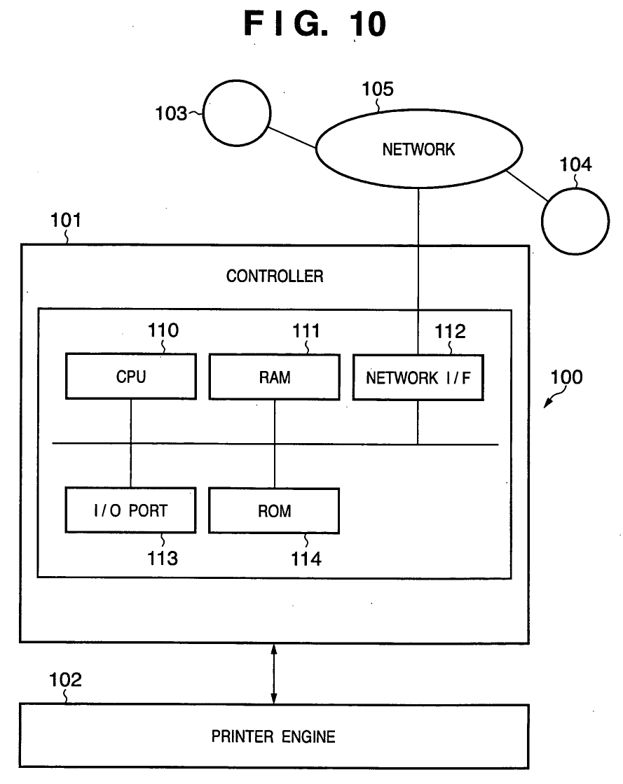

FIG. 10 is a block diagram showing the arrangement of an image forming apparatus (color printer) as an example of a device which executes processing according to this embodiment. Note that although the embodiment will be explained by taking this color printer as an example, the present invention is not limited to this example and is also applicable to office machines such as a personal computer (PC), copying machine, and facsimile apparatus and household electric appliances such as a DVD recording/playback apparatus.

Referring to FIG. 10, a controller 101 controls the overall operation of a color printer 100. A printer engine 102 forms an image on a printing medium such as a printing sheet by, e.g., an inkjet method or electrophotography. A network 105 connects various devices 103 and 104 such as a household electric appliance and/or business machine, in addition to the printer 100. Although only two devices 103 and 104 are shown in FIG. 10, the number of devices are of course not limited to two.

A CPU 110 controls the operation of the color printer 100 in accordance with programs stored in a ROM 114. A RAM 111 is used as a work area which temporarily stores various data when processing is performed by the CPU 110. An input/output (I/O) port 113 inputs and outputs various signals between individual units such as the printer engine 102 and the CPU 110. A network interface 112 controls communication with the network 105, and can exchange data with various devices connected to the network 105.

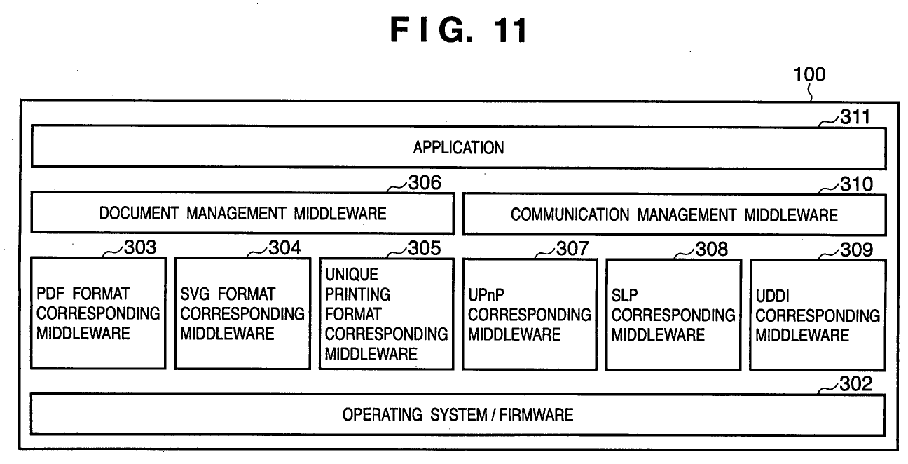

FIG. 11 is a view for explaining the configuration of software installed in the color printer 100 according to the embodiment of the present invention. This program is stored in the ROM 114 of the controller 101.

The color printer 100 is a device having functions according to this embodiment, and is a high-end color printer connectable to the network 105. The color printer 100 is given functions such as printing data management, reprinting, and log management, in addition to functions of receiving document data or printing data from a client such as a PC and printing a full-color image like an ordinary printer. The software configuration of the color printer 100 is as follows. First, operating system/firmware 302 which provides the basic processing is installed. Middleware programs 303 to 310 which provide various common functions are installed in the layer above the operating system/firmware 302. An application 311 is installed in the uppermost layer. The application 311 is used to provide the additional functions of the color printer 100, and performs processing such as the log management described above. Although FIG. 10 shows only one application 311 for convenience of explanation, a plurality of applications may also exist.

Details of the middleware programs 303 to 310 will be explained below.

Reference numerals 303 to 306 denote middleware programs for managing document data including printing data having arrived at the color printer 100. The middleware programs for managing document data include middleware programs corresponding to their respective data formats, such as PDF format corresponding middleware 303, SVG format corresponding middleware 304, and unique printing format corresponding middleware 305, and document management middleware 306 which provides an interface with which the application 311 integrally controls the middleware programs 303 to 305. The middleware programs 303 to 305 and 306 form a hierarchical structure, and the application 311 controls the middleware programs 303 to 305 via the document management middleware 306.

Reference numerals 307 to 310 denote middleware programs for implementing communication processes across the network 105. Similar to the document management middleware 306, these communication process middleware programs include middleware programs corresponding to their respective communication protocols, such as UPnP corresponding middleware 307, SLP corresponding middleware 308, and UDDI corresponding middleware 309, and communication management middleware 310 which provides an interface with which the application 311 integrally controls these middleware programs. The middleware programs 307 to 309 and 310 form a hierarchical structure, and the application 311 controls the middleware programs 307 to 309 via the communication management middleware 310.

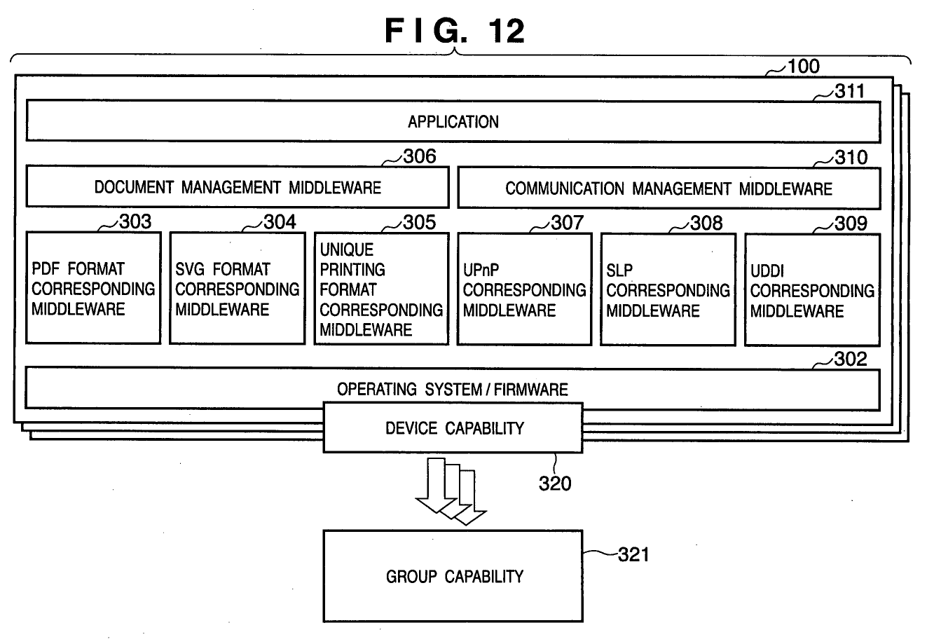

FIG. 12 is a view conceptually showing processing which occurs when the color printer 100 is powered on to start operating.

First, pieces of capability (function) information of the operating system/firmware 302, the application 311, and each software incorporated into the color printer 100 are collected, and device capability 320 as capability information of the color printer 100 is generated. Device capability 320 of each of the devices 103 and 104 is similarly generated. The individual devices transmit and totalize these device capabilities across the network 105, thereby forming group capability 321 of the network 105. The contents of the group capability 321 formed by the device capabilities 320 of the individual devices change in accordance with the functions and abilities of the devices connected to the network 105. For example, when a digital camera is connected to the network 105, it is determined that a color management function which increases the color reproducibility when image information obtained by the digital camera is printed is essential, because the color printer 100 is a printer capable of full-color image printing. In this case, capability information including the color management function is generated as the group capability 321. On the other hand, when a monochrome scanner is connected to the network 105 instead of a digital camera, capability information including a monochrome printing function in a draft mode which can follow a high-speed scanning process is generated. Pieces of function information such as a communication protocol which can be used in common and a corresponding data format are also generated as the group capability 321.

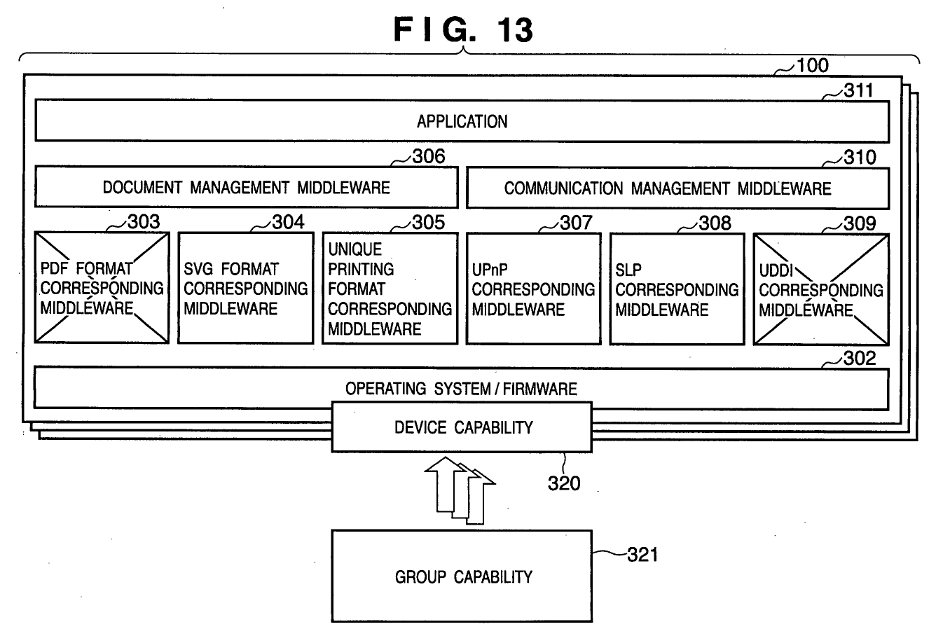

FIG. 13 shows the state in which some middleware programs incorporated into the color printer 100 stop operating due to an adaptation process using the group capability 321 and device capability 320 in the color printer 100. An example of processing which leads the color printer 100 to this state will be explained below.

First, it is deduced on the basis of the group capability 321 calculated from the device capability of each device that none of the devices connected to the network 105 uses UDDI as a communication means (a communication means for searching for another device). As a consequence, the UDDI corresponding middleware 309 in each device stops operating (indicated by “x” in FIG. 13). It is also deduced by the group capability 321 that none of the input devices connected to the network 105 supports PDF-format data transmission. In this case, it is determined that there is no possibility that the PDF format corresponding middleware 303 in the color printer 100 as an output device is used, so the PDF format corresponding middleware 303 stops operating (indicated by “x” in FIG. 13).

It should be noted that the functions which the color printer 100 including the application 311 can provide to the user in this state remain unchanged. That is, since the UDDI corresponding middleware 309 and PDF format corresponding middleware 303 cannot be used in the present devices connected to the network 105, the functions which the device network 105 including the color printer 100 can provide to the user remain exactly the same even if these middleware programs stop operating.

Also, the application 311 continues to perform processing via the communication management middleware 310 in the communication process, and via the document management middleware 306 in the document management. Therefore, the application 311 is not adversely affected by the operation stop of the UDDI corresponding middleware 309 and PDF format corresponding middleware 303.

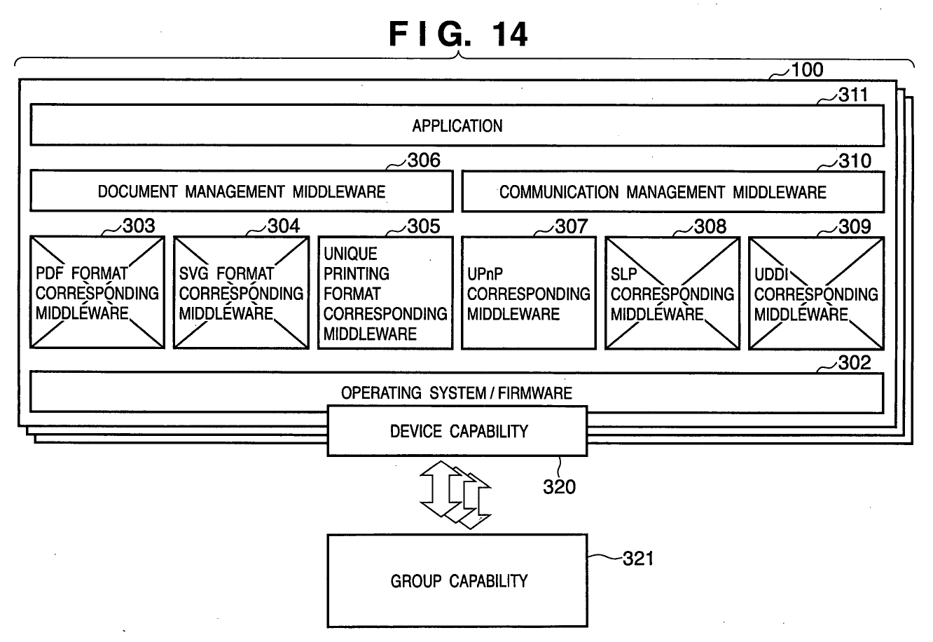

FIG. 14 is a view showing a case in which recursive adaptation is performed by generating group capability information 321 again from the device capability information 320 thus changed.

This process is normally recursively performed under a converging condition such the time or count. FIG. 14 shows a case in which it is found that the operations of the SLP corresponding middleware 308 and SVG format corresponding middleware 304 can be stopped.

In the color printer 100 according to this embodiment as described above, it is unnecessary to keep all the plurality of installed middleware programs operable; it is possible to keep only really necessary middleware programs operable and stop the operations of the rest in accordance with the states and abilities of the devices connected to the network 105.

Note that in this embodiment, each middleware is activated before adaptation by the group capability 321 and stopped after the adaptation. However, the present invention is also applicable to a case in which each middleware is stopped in advance and activated where necessary. The present invention can also be applied to a case in which adaptation is performed by combining the activation/stop control operations of the individual middleware programs.

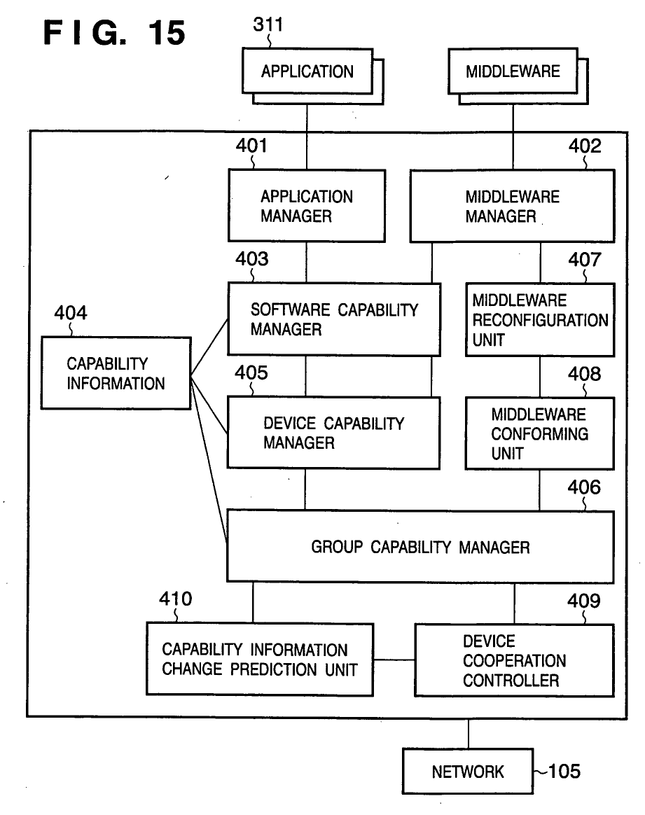

FIG. 15 is a view for explaining the functional blocks of the software structure of the color printer 100 according to the embodiment of the present invention.

An application manager 401 manages and stores one or a plurality of application software programs for implementing major functions of a network corresponding device which can be controlled across the network 105. Referring to FIG. 15, the application 311 is stored. A middleware manager 402 simultaneously manages and stores the plurality of middleware programs 303 to 310 for collectively providing common functions of the color printer 100, represented by network control, in response to requests from the application software 311.

A software capability manager 403 gives capability information 404 to each of various software programs including the firmware which achieves control to the hardware functions of the color printer 100, the middleware programs described above, and the application software 311, and manages the capability information 404. The capability information 404 is obtained by combining status information indicating, e.g., the status and state of the device, and profile information indicating, e.g., the function, ability, and specification of the device. The middleware manager 402 manages middleware to be managed, by using the capability information 404 given by the software capability manager 403. In this case, the capability information 404 contains information which hierarchically expresses the mutual functional dependences of the individual middleware programs.

A device capability manager 405 generates device capability information as capability information of each device, on the basis of the capability information 404, provided by the software capability manager 403, of a plurality of software programs installed in the device. A group capability manager 406 collects, across the network 105, the device capability information 320 provided by the device capability manager 405. The group capability manager 406 calculates the group capability information 321 of a device group including a plurality of devices on the network 105. A middleware reconfiguration unit 407 dynamically reconfigures each installed middleware when the color printer 100 is in operation. A middleware conforming unit 408 conforms middleware stored in each device via the middleware reconfiguration unit 407, on the basis of the group capability information 321 generated by the group capability manager 406.

A capability information change prediction unit 410 analyzes the change in group capability information generated by the group capability manager 406 with time, and predicts a future change in capability information. Also, when the group capability manager 406 calculates the group capability information 321 from the device capability information 320, a device cooperation controller 409 uses the change prediction by the capability information change prediction unit 410. In this manner, the device cooperation controller 409 predicts information of the overall group capability in the future by using the past status, on the basis of not only the change in device capability 320 with time but also the change in group capability as a set with time, and the contents of the change. In addition, a cooperation of the whole device group is performed by exchanging pieces of information predicted by the group capability managers 406 operating on difference devices.

An example of the capability information 404 processed by the software capability manager 403 according to this embodiment is the same as the profile shown in FIG. 3A. As shown in FIG. 3A, individual elements forming the capability information 404 have a hierarchical multi-stage structure by which only necessary information can be obtained by tracing the layers.

Referring to FIG. 3A, the profile is classified into fixed static information (Static Information) and service (Service) and status information (Status) which can change with time. The static information (Static Information) includes an IP address (IPAddress) and type name (DeviceType) which do not change. The service (Service) includes services A and B, and service A (ServiceA) includes a name and a version (Version). The status (Status) includes power (Power) and status (Status). The version and status are managed together with time information.

An example obtained by describing the structure shown in FIG. 3A in XML is the same as FIG. 3B.

In FIG. 3B, reference numeral 800 denotes the entire profile shown in FIG. 3A; 801, the history of the API version; 802, the history of ON/OFF of the power supply; and 803, the history of the status. For example, the power history 802 indicates that the power supply is turned on at 00:00:00, Jan. 1, 2004, turned-off at 12:00:00, Feb. 1, 2004, and turned on at 15:30:00, Mar. 1, 2004. Likewise, the status history 803 records the state transitions such as an idle state (idle), down state (down), and activation state (up), together with date/time information.

An example obtained by forming a snap shot of the latest capability (profile) information from the capability (profile) structure shown in FIGS. 3A and 3B is the same as FIG. 4A.

Reference numeral 900 denotes the XML describing the latest capability information; 901, the latest API version information (version “2.0”); 902, the latest power information (power on (ON)); and 903, the latest status information (“up” the activation state).

An example obtained by forming a snap shot of capability (profile) information at 13:00, Feb. 1, 2004 from the capability (profile) structure shown in FIGS. 3A and 3B is the same as FIG. 4B.

In this case, version “1.1”, power off (OFF), and down are respectively described in the API version information 1001, power information 1002, and status information 1003, on the basis of information in the version history 801, power ONIOFF history 802, and status history 803 at 12:00, Feb. 1, 2004 immediately before 13:00, Feb. 1, 2004.

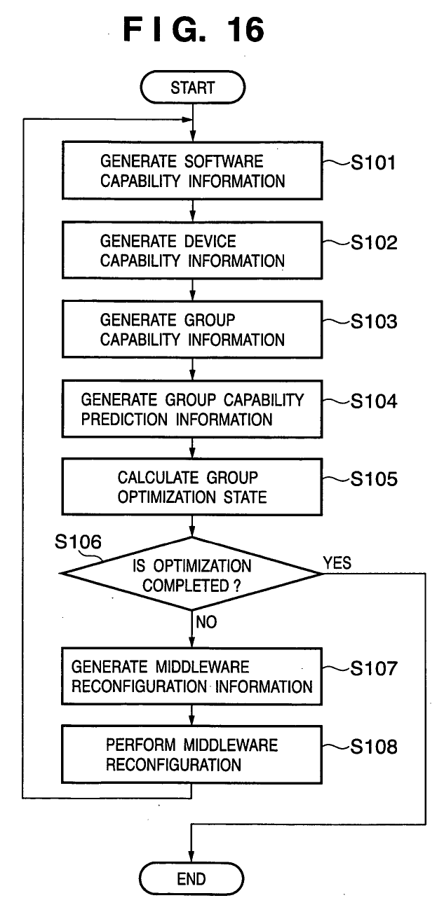

FIG. 16 is a flowchart for explaining an outline of a middleware control configuration process according to the embodiment of the present invention. The individual steps of the process will be explained below together with the arrangement described above.

First, in step S101, software capability information of each software installed in a device is generated. This process is performed by collecting, into the capability information 404, pieces of information of various software programs such as application software, middleware, and firmware installed in the device from the software capability manager 403 via the application manager 401 and middleware manager 402 shown in FIG. 15. The collected capability information 404 has the structure shown in FIG. 3A. Accordingly, the transitions of not only the present information but also the past information are stored.

Then, in step S102, the device capability information 320 as capability information of each device is generated from the software capability information collected in step S101. Other devices are notified of the information 320 across the network 105. This notification is performed by the device capability manager 405 shown in FIG. 15. The device capability information 320 generated and notified to the other devices is a set of the software capability information generated in step S101. As in step Slol, therefore, the capability information 404 having the structure shown in FIG. 3A is used, and the transitions of not only the present information but also the past information are generated and stored.

In step S103, the device capabilities of the other devices connected to the network 105 are obtained and processed to generate group capability information 321 of a group including a plurality of devices configuring the network 105. This process is performed by the group capability manager 406 shown in FIG. 15. The group capability information 321 generated in step S103 is a set of pieces of device capability information generated in the individual devices. As in step S101, therefore, the capability information 404 having the structure shown in FIG. 3A is used, and the transitions of not only the present information but also the past information are generated and stored.

In step S104, group capability prediction information which predicts a change in group capability information in the future is generated from the group capability information 321 generated in step S103. This process is performed by the device cooperation controller 409 by requesting acquisition of future capability information to the capability information prediction unit 410, on the basis of the group capability information 321 generated by the group capability manager 406. Details of the process will be described later.

Assume, for example, that device 1 which supports only UPnP and devices 2 and 3 which support UPnP and SLP (Service Location Protocol, RFC2165) are connected to the network 105 (FIG. 10), and all these devices are operating at time T1. Assume also that SLP is lighter than UPnP and consumes the computer resources of the device less than UPnP. In this case, the device cooperation controller 409 of each device determines that it is appropriate to use UPnP in all the three devices, from the group capability information 321 formed by the three devices. Accordingly, each device is adapted (FIG. 14) so as not to use any middleware which supports a protocol other than UPnP. Assume that at time T2, device 4 which supports both UPnP and SLP is added to the network 105, and device 1 enters an idle state. From the group capability information 321 at this point, it is possible to determine that both UPnP and SLP are appropriate protocols and SLP which is lighter than UPnP is to be selected.

In this embodiment, however, the capability information change prediction unit 410 determines that UPnP must be used if device 1 returns from the idle state, from the group capability information 321 in the past (at time T1). That is, when the device cooperation controller 409 requests acquisition of capability information in the future (T3) to the capability information prediction unit 410, group capability information is generated by predicting a case in which device 1 which is in the idle state at present (time T2) switches to an operation state. Accordingly, in the following processing starting from step S105 of calculating a group adaptation state, UPnP is still selected as an appropriate protocol in this example.

In step S105, a group adaptation state indicating an adaptation process necessary for the whole device group is calculated from the group capability prediction information generated in step S104. This process is performed by the device cooperation controller 409 by using the group capability prediction information generated by the capability information prediction unit 410. From the group capability information thus predicted, the present and future states of each device forming the predicted group capability information and the present and future states of each middleware incorporated into the device are predicted. The predicted states are collated with information indicating an appropriate state when a network between devices having specific device capability 320 is constructed, and the difference is reduced. In this way, an appropriate state of the whole device group is calculated. That information to be collated for adaptation, which indicates an appropriate state when a network between devices having specific device capability information 320 is constructed, may be a necessary initial value which is given together with combination information to each device in advance, or information acquired by learning as the processing of the device group advances.

In step S106, whether the adaptation is completed is determined. In this step, the converging condition of the adaptation process is checked, and the adaptation process is terminated if the condition is met. This converging condition is given by, e.g., the elapsed time of processing or the number of times of processing. However, this condition is not particularly limited. This process is performed by the device cooperation controller 409.

If it is determined in step S106 that the adaptation process is to be continued, the flow advances to step S107, and the group adaptation state calculated in step S105 is compared with the device capability information 320 of the device calculated in step S102, thereby generating middleware reconfiguration information. This process is performed by the middleware conforming unit 408 shown in FIG. 15.

In step S108, dynamic reconfiguration including the start and stop of middleware is performed by using the reconfiguration information generated by the middleware conforming unit 408. This process is performed by the middleware reconfiguration unit 407 shown in FIG. 15. The flow then returns to step S101 again to repeat this adaptation process.

An outline of the process (S104) performed by the device cooperation controller 409 to request the group capability information 321 necessary for determination of device cooperation in the capability information change prediction unit 410 according to the embodiment of the present invention will be explained below with reference to the flowchart in FIG. 7.

First, in step S700, the device cooperation controller 409 transmits a capability information (profile information) acquisition request to the capability information change prediction unit 410. Then, in step S701, the capability information change prediction unit 410 having received this capability information (profile information) acquisition request determines whether the time to which the requested capability information (profile information) belongs is the present time, past, or future. If it is determined in step S701 that the time is the past, the flow advances to step S702, and a snap shot of the designated date/time is formed from the capability information stored in the group capability manager 406. After that, the flow advances to step S707.

If it is determined in step S701 that the time is the present time, the flow advances to step S703, and the latest snap shot is formed from the stored capability information. The flow then advances to step S707.

If it is determined in step S701 that the time is the future, the flow advances to step S704, and the log information stored in the group capability manager 406 is analyzed. In step S705, a value which the log information can take is predicted. This prediction is performed by a method by which the change frequency of the stored log information and the relation of the information with another information are calculated, and a state having the highest probability as the next state of the information is determined. In step S706 a capability information snap shot to be returned is formed. After that, the flow advances to step S707.

After one of steps S702, S703, and S706 is thus executed, the flow advances to step S707, and the capability information (profile information) formed on the basis of the request is returned to the device cooperation controller 409.

### Other Embodiment

Although the embodiments have been explained in detail above, the present invention can take an embodiment as a system, apparatus, method, program, storage medium (recording medium), or the like. More specifically, the present invention is applicable to a system comprising a plurality of devices, or an apparatus comprising a single device.

The objects of the present invention can also be achieved by supplying a medium recording the program code of software for implementing the functions of the above-mentioned embodiments to an apparatus or a computer (or a CPU or MPU) of the apparatus, and reading out and executing the program code stored in the storage medium by the apparatus or the computer of the apparatus. In this case, the program code itself read out from the storage medium implements the functions of the embodiments, and the storage medium storing the program code constitutes the present invention.

This program can take any form as long as it has the function of a program. Examples are an object code, a program executed by an interpreter, and script data to be supplied to an OS.

Examples of the recording medium for supplying the program are a hard disk, optical disk, magnetooptical disk, MO, CD-ROM, CD-R, CD-RW, magnetic tape, nonvolatile memory card, ROM, and DVD (DVD-ROM and DVD-R).

The program may also be supplied by downloading it from a homepage of the Internet into a recording medium such as a hard disk by using the browser of a client computer. That is, it is possible to connect to the homepage, and download the computer program itself of the present invention or a compressed file including an automatic installation function from the homepage. It is also possible to divide the program code forming the program of the present invention into a plurality of files, and download the individual files from different homepages. That is, the present invention also includes a WWW server which allows a plurality of users to download a program file for implementing the functions and processing of the present invention by a computer.

Furthermore, the program of the present invention may also be distributed to users after being encrypted and stored in a storage medium such as a CD-ROM. In this case, only a user who has cleared predetermined conditions is allowed to download key information for decryption from a homepage across the Internet. The encrypted program can be executed and installed in a computer by using the key information.

The present invention is not limited to the case in which the functions of the above-mentioned embodiments are implemented by executing the readout program code by the computer. That is, the present invention also includes a case in which an OS (Operating System) or the like running on the computer performs part or the whole of actual processing on the basis of instructions by the program code, thereby implementing the functions of the embodiments.

The present invention further includes a case in which the program read out from the storage medium is written in a memory of a function expansion board inserted into the computer or of a function expansion unit connected to the computer, and a CPU or the like of the function expansion board or function expansion unit performs part or the whole of actual processing on the basis of instructions by the program code, thereby implementing the functions of the above embodiments.

When the present invention is applied to the storage medium described above, this storage medium stores the program code which executes the processes corresponding to the flowcharts explained previously.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-225550, filed Aug. 3, 2005, which is hereby incorporated by reference herein in its entirety.

What is claimed is:

1. A control apparatus comprising:
a receiving unit adapted to receive, from a device to be controlled, information concerning said device and related to time;
an obtaining unit adapted to obtain specific-time information concerning said device to be controlled, on the basis of the information concerning said device to be controlled, related to time, and received by said receiving unit; and
a control unit adapted to control said device to be controlled, on the basis of the specific-time information.

2. The apparatus according to claim 1, further comprising an application and middleware, said middleware forming said receiving unit, and said application forming said control unit.

3. The apparatus according to claim 1, wherein the information related to time contains software version information of said device to be controlled.

4. The apparatus according to claim 1, wherein said control unit controls said device to be controlled, on the basis of a specific-time version of software of said device to be controlled.

5. The apparatus according to claim 1, wherein said obtaining unit predicts future information on the basis of past information concerning said device to be controlled.

6. The apparatus according to claim 1, wherein said obtaining unit obtains the information concerning said device to be controlled and related to time, within a theoretical range of the information.

7. A control method comprising steps of:
receiving, from a device to be controlled, information concerning the device and related to time;
obtaining specific-time information concerning the device to be controlled, on the basis of the received information concerning the device to be controlled and related to time; and
controlling the device to be controlled, on the basis of the specific-time information.

8. A method according to claim 7, wherein the information related to time contains software version information of the device to be controlled.

9. A method according to claim 7, wherein in the control step, the device to be controlled is controlled on the basis of a specific-time version of software of the device to be controlled.

10. A computer program stored in a memory, comprising steps of:
receiving, from a device to be controlled, information concerning the device and related to time;
obtaining specific-time information concerning the device to be controlled, on the basis of the received information concerning the device to be controlled and related to time; and
controlling the device to be controlled, on the basis of the specific-time information.

11. A program according to claim 10, wherein the information related to time contains software version information of the device to be controlled.

12. A program according to claim 10, wherein in the control step, the device to be controlled is controlled on the basis of a specific-time version of software of the device to be controlled.

13. A communication device which communicates with another device across a network, comprising:
a receiving unit adapted to receive, from said another device, information concerning said another device and related to time; and
a configuration unit adapted to configure middleware on the basis of the information concerning said another device, related to time, and received by said receiving unit.

14. A device according to claim 13, wherein said configuration unit invalidates and/or validates said middleware.

15. A device according to claim 13, wherein said configuration unit configures middleware in accordance with whether said middleware is necessary for a cooperation with said another device.

16. A middleware configuration method in a communication device which communicates with another device across a network, comprising steps of:
receiving, from the other device, information concerning the other device and related to time; and
configuring middleware on the basis of the received information concerning the other device, related to time.

17. A method according to claim 16, wherein in the configuration step, the middleware is invalidated and/or validated.

18. A method according to claim 16, wherein in the configuration step, middleware is configured in accordance with whether the middleware is necessary for a cooperation with the other device.

19. A computer program for a communication device which communicates with another device across a network, comprising steps of:
receiving, from the other device, information concerning the other device and related to time; and
configuring middleware on the basis of the received information concerning the other device, related to time.

20. A program according to claim 19, wherein in the configuration step, middleware is configured in accordance with whether the middleware is necessary for a cooperation with the other device.
